(19) United States
(12) Patent Application Publication
(10) Pub. No.: US 2010/0181882 A1
(43) Pub. Date: Jul. 22, 2010

(54) Guide Mechanism for Door and Apparatus Provided Therewith

(76) Inventor: Tung-Ping LEE, Taipei Hsien (TW)

Correspondence Address: G. LINK CO., LTD., 3550 BELL ROAD, MINOOKA, IL, 60447, US

(21) Appl. No.: 12/206,406

(22) Filed: Sep. 8, 2008

(30) Foreign Application Priority Data
Sep. 12, 2007 (TW) 096215335

(51) Int. Cl. A47B 96/00; E05D 15/00

(52) U.S. Cl. 312/326; 49/402

(57) ABSTRACT

A guide mechanism for a door comprises a first guide unit and a second guide unit; the first guide unit is coupled to a second side frame plate at an opening end of a casing; the second guide unit is coupled to a movable side of the door; the second guide unit is disposed with a groove, a upside of an outer end of the groove is disposed with a propping inclined face; an inner end of the propping inclined face is lower than an outer end thereof ; the movable side of the door will then not incline downward when the groove accepts the first guide unit and the first guide unit is propped against a upside of an inner side of the groove.

### BACKGROUND OF THE INVENTION

1. Field of the Invention

The present invention relates to a door of an apparatus, and more particularly to a guide mechanism for a door of an apparatus such as computer or server.

2. Description of Related Art

Sides of some computer facilities are respectively pivotally to a door to shield a front end of a computer housing, for example, a shielding door coupled to a computer facility disclosed by Taiwan Patent Publishing No. 543823, comprising at least one guide post fixed on a door, two axial sides of the guide post are respectively projected with a shaft portion, and the guide is pointed toward a shielded face of the computer facility; the door can be opened or closed by pivotally coupling the two shaft portions to corresponding pivoting portions disposed on one end of the computer facility.

Furthermore, a door on-off apparatus of a computer mainframe disclosed by Taiwan Patent No. M260079, mainly allowing a groove to be disposed on a upper part of one side in front of the computer mainframe; a pivoting shaft is pivotally coupled onto the groove, and a door is pivotally coupled to the pivoting shaft; the door is disposed with at least one clipping portion pointed toward a shielded face, and a plurality of beams matchable to the clipping portion are disposed on a position of the shielded face capable of being clipped by this clipping portion; two sides of the beam are hollow, and allows clipping sheets on two sides of the clipping portion to be extended into hollow portions so as to enable the beam to be clipped conveniently.

When a door is wider and heavier, a movable side of the door will incline downward owing to the weight of the door itself. Thus, bosses are generally disposed on a lower end of the door, and the movable side is not allowed to such extent as to incline downward by propping bosses against a corresponding lower frame plate of a housing when the door is closed. But, as the lower frame plate is a mirror finished material, a surface thereof is very shining and bright; a mirror face is damaged to influence an outlook thereof if it is exerted by the friction force of the bosses.

### SUMMARY OF THE INVENTION

For allowing a door of an apparatus such as computer or server to be more smoothly and a lower fame plate of a lower end thereof not to be damaged while being closed or opened, the present invention is proposed.

The main object of the present invention is to provide a guide mechanism for a door and an apparatus provided therewith, capable of guiding the closing and opening of the door smoothly, and allowing a movable side of the door not to incline downward to assure a proper and acceptable outlook of the door after the door is closed.

Another object of the present invention is to provide a guide mechanism for a door and an apparatus provided therewith, allowing a lower end of the door not to damage a lower frame plate at a lower end thereof, an outlook thereof not to be influenced and a user to close the door without feeling a difference on strength.

A guide mechanism for a door proposed by the present invention is used for guiding the door not to incline downward while being closed, a pivoting side of the door is pivotally coupled to a first side frame plate of an opening end of a casing, the guide mechanism comprises:

a first guide unit, coupled to a second side frame plate of the opening end of the box;
a second guide unit, coupled to a movable side of the door;
wherein, at least one of the first guide unit and the second guide unit is provided with a propping inclined face, the movable side of the door will then not incline downward as the first guide unit is propped against the second guide unit to assure the proper outlook of the door.

### BRIEF DESCRIPTION OF THE DRAWINGS

The present invention can be more fully understood by reference to the following description and accompanying drawings, in which:

FIG. 1 is a perspective view, showing a door of the present invention in an open state;

FIG. 2 is a partly sectional view, showing a guide mechanism of a first preferred embodiment according to the present invention when a door is not closed completely;

FIG. 3 is a partly sectional view, showing a guide mechanism of a first preferred embodiment according to the present invention when a door is closed;

FIG. 4 is a perspective of a second guide unit of the present invention; and

FIG. 5 is a partly sectional view, showing a guide mechanism of a second preferred embodiment according to the present invention when a door is closed.

### DETAILED DESCRIPTION OF THE PREFERRED EMBODIMENTS

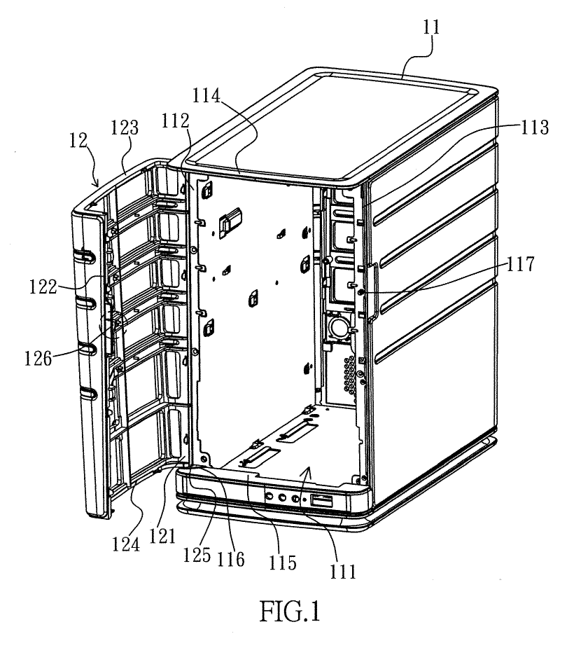

Please refer to FIGS. 1, 2 and 3. A guide mechanism for a door according to the present invention is used for guiding a door 12 of an opening end of a casing (housing) 11 of an apparatus such as a computer or server to allow a movable side 122 of the door 12 not to incline downward when the door 12 is closed. Two sides, upper and lower ends of an end of an opening 111 at a front end of the casing 11 are respectively provided with a first side frame plate 112, a second side frame plate 113, a upper frame plate 114 and a lower frame plate 115; upper and lower ends of the first side frame plate 112 are respectively disposed with a first pivoting unit 116. The door 12 has a pivoting side 121, a movable side 122, a upper side 123 and a lower side 124; upper and lower ends of the pivoting side 121 are respectively disposed with a second pivoting unit 125; the second pivoting unit 125 and the first pivoting unit 116 are pivotally coupled to each other, for example, coupled to each other through corresponding shaft and hole to allow the pivoting side 121 and the first side frame plate 112 to be pivotally coupled to each other as FIG. 1 shows.

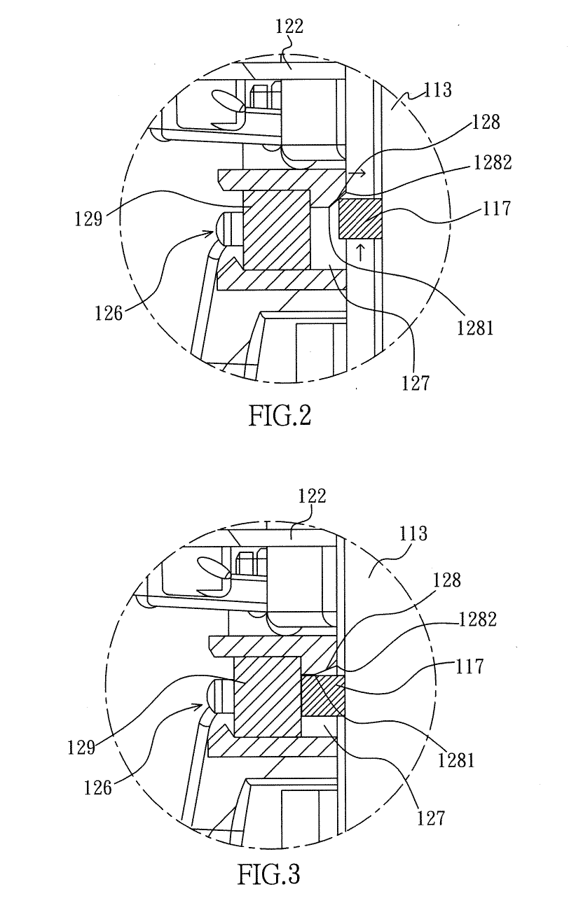

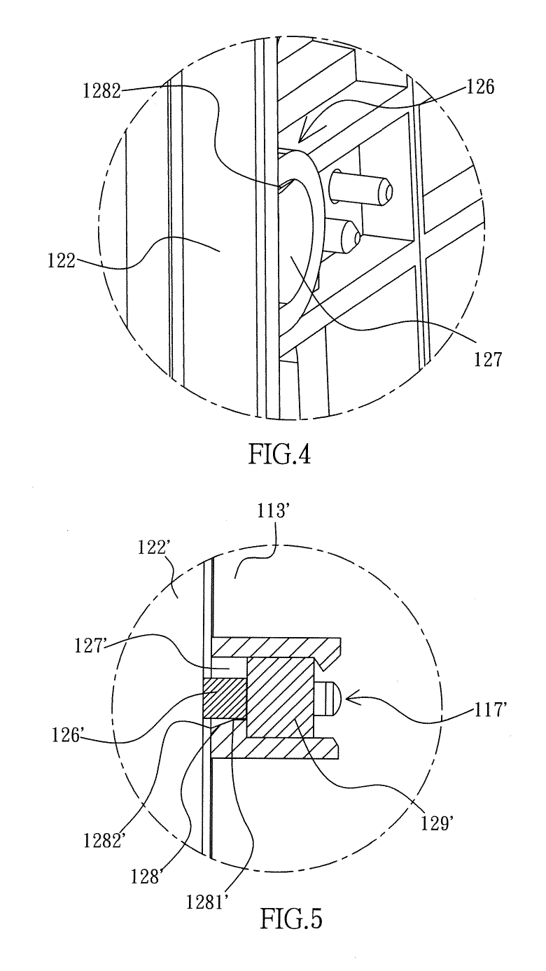

Please refer to FIGS. 1 to 4. A guide mechanism of a door of a first preferred embodiment according to the present invention comprises the second side frame plate 113 of the casing 11 coupled to a first guide unit 117, and the movable side 122 of the door 12 coupled to a second guide unit 126 as FIG. 2 shows. The first guide unit 117 is a cylindrical magnetic element capable of sensing magnetism or having magnetism; the second guide unit 126 is disposed with a groove 127, a upper side of an outer end of the groove 127 id disposed with a propping inclined face 128 and an inner end 1281 of the propping inclined face 128 is lower than an outer end 1282 thereof; an inside of the groove 127 is coupled to a magnetic unit 129; the magnetic unit 129 can sense magnetism or has magnetism. The casing 11 of the present embodiment is a computer housing.

The first guide unit 117 and the second guide unit 126 are corresponding to each other. The second guide unit 126 is allowed to automatically move toward the first guide unit 117 to cause them to be absorbed together and further to cause the first guide unit 117 to be propped against a upside of an inside of the groove 127 by means of a mutual magnetic force of the first guide 117 and the magnetic unit 129 when the movable side 122 of the door 12 is close to the second side frame plate 113 and the first guide unit 117 is propped against the outer end 1282 of the propping inclined face 128 of the second guide unit 126 as FIG. 3 shows.

In the process of automatic absorption of the first guide unit 117 and the second guide unit 126, the movable side 122 is automatically moved toward and drawn close to the second side frame plate 113 and in the meantime, the movable side 122 is allowed to move upward a small preset distance at the same time it is drawn close to the second side frame plate 113 to enable the movable side 122 not to incline downward as the movable side 122 is closed by placing restriction on the propping inclined face 128 through the first guide unit 117. Thus, the upper side 123 and the lower side 124 of the door 12 can be accurately closed between the upper frame plate 114 and the lower frame plate 115 of the casing 11.

Please refer to FIGS. 1 and 5. A guide mechanism of a door of a second preferred embodiment according to the present invention allows a second side frame plate 113′ and a movable side 122′ equivalent to the second side frame plate 113 and the movable side 122 in the first embodiment to be respectively disposed with a first guide unit 117′ and the second guide unit 126′. But, the first guide unit 117′ is disposed with a groove 127′, a lower side of an outer end of the groove 127′ is disposed with a propping inclined face 128′, an inner end 1281′ of the propping inclined face 128′ is higher than an outer end 1282′ thereof; an inner side of the groove 127′ is coupled to a magnetic unit 129′; the magnetic unit 129′ can sense magnetism or has magnetism, and the second guide unit 126′ is cylindrical magnetic element capable of sensing magnetism or have magnetism. The same effect of allowing the movable side 122′ not to incline downward in a door-closing state can also be attained when the second guide unit 126′ is propped against a downside of the inner side of the groove 127′.

The present invention allows a door to be closed more smoothly and not to damage a lower frame plate below it to influence the outlook. Moreover, a movable side of the closed door will not incline downward to assure a proper outlook of the door and a user feels no strength difference to close door.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A guide mechanism for a door, used for guiding said door at an opening end of a casing not to incline downward while being closed, a pivoting side of said door is coupled to a first side frame plate at said opening end of said casing, said guide mechanism comprising:
a first guide unit, coupled to a second side frame plate at said opening end of said casing; and
a second guide unit, coupled to a movable side of said door;
wherein at least one of said first guide unit and said second guide unit is provided with a propping inclined face, said movable side of said door will then not incline downward when said first guide unit is propped against said second guide unit.

2. The guide mechanism for a door according to claim 1, wherein said second guide unit is disposed with a groove, a upside of an outer end of said groove is disposed with said propping inclined face; an inner end of said propping inclined face is lower than an outer end thereof; said movable side of said door will then not incline downward when said groove accepts said first guide unit and said first guide unit is propped against a upside of an inner side of said groove.

3. The guide mechanism for a door according to claim 2, wherein an inner side of said groove is disposed with a magnetic unit, a magnetic force exists between said magnetic unit and said first guide unit.

4. The guide mechanism for a door according to claim 3, wherein said magnetic unit has magnetism.

5. The guide mechanism for a door according to claim 3, wherein said first guide unit has magnetism.

6. The guide mechanism for a door according to claim 1, wherein said first guide unit is disposed with a groove; a downside of an outer end of said groove is disposed with said propping inclined face; an inner end of said propping inclined face is higher than an outer end thereof; said movable side of said door will then not incline downward when said groove accepts said second guide unit and said second guide unit is propped against a downside of an inner side of said groove.

7. The guide mechanism for a door according to claim 6, wherein an inner side of said groove is disposed with a magnetic unit, a magnetic force exists between said magnetic unit and said second guide unit.

8. The guide mechanism for a door according to claim 7, wherein said magnetic unit has magnetism.

9. The guide mechanism for a door according to claim 7, wherein said second guide unit has magnetism.

10. An apparatus provided with a guide mechanism, comprising a guide mechanism for a door mentioned in claim 1, wherein said casing is a housing of said apparatus, and said door is a door of said housing.

11. The apparatus provided with a guide mechanism according to claim 10, wherein said apparatus is one of a computer and a server.

12. The apparatus provided with a guide mechanism according to claim 11, wherein said second guide unit is disposed with a groove, a upside of an outer end of said groove is disposed with said propping inclined face; an inner end of said propping inclined face is lower than an outer end thereof; said movable side of said door will then not incline downward when said groove accepts said first guide unit and said first guide unit is propped against a upside of an inner side of said groove.

13. The apparatus provided with a guide mechanism according to claim 12, wherein an inner side of said groove is disposed with a magnetic unit, a magnetic force exists between said magnetic unit and said first guide unit.

14. The apparatus provided with a guide mechanism according to claim 13, wherein said magnetic unit has magnetism.

15. The apparatus provided with a guide mechanism according to claim 13, wherein said first guide unit has magnetism.

16. The apparatus provided with a guide mechanism according to claim 11, wherein said first guide unit is disposed with a groove; a downside of an inner end of said groove is disposed with said propping inclined face; an inner end of said propping inclined face is higher than an outer end thereof; said movable side of said door will then not incline downward when said groove accepts said second guide unit and said second guide unit is propped against a downside of an inner side of said groove.

17. The apparatus provided with a guide mechanism according to claim 16, wherein an inner side of said groove is disposed with a magnetic unit, a magnetic force exists between said magnetic unit and said second guide unit.

18. The apparatus provided with a guide mechanism according to claim 17, wherein said magnetic unit has magnetism.

19. The apparatus provided with a guide mechanism according to claim 17, wherein said second guide unit has magnetism.
